(19) United States
(12) Patent Application Publication
(10) Pub. No.: US 2003/0229721 A1
(43) Pub. Date: Dec. 11, 2003

(54) Address virtualization of a multi-partitionable machine

(76) Inventors: Thomas J. Bonola, Magnolia, TX (US); John M. MacLaren, Cpress, TX (US)

Correspondence Address: Michael G. Fletcher, Fletcher, Yoder & Van Someren, P.O. Box 692289, Houston, TX, 77269-2289, US

(21) Appl. No.: 10/164,102

(22) Filed: Jun. 5, 2002

(51) Int. Cl. G06F 15/16

(52) U.S. Cl. 709/253

(57) ABSTRACT

A mechanism for viewing fixed addresses in a multi-processor system configurable to provide multiple logical partitions. The techniques permit multiple partitions by mapping the fixed range of system addresses into multiple virtual addresses viewable by respective port agents. By providing one or more virtual address ranges for each port, the physical addresses of the system are abstracted from the view of the port agents.

### BACKGROUND OF THE INVENTION

1. Field of the Invention

This invention relates generally to improved performance in a multi-processing system and, more particularly, to a technique for an operating system to view logical partition resources in a multi-processing system.

2. Background Of The Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Computer usage has increased dramatically over the past few decades. With the advent of standardized architectures and operating systems, computers have become virtually indispensable for a wide variety of uses from business applications to home computing. Whether a computer system includes a single personal computer or a network of computers, computers today rely on processors, associated chip sets, and memory chips to perform most of the processing of requests throughout the system. The more complex the system architecture, the more difficult it becomes to efficiently manage and process the requests.

A conventional computer system typically includes one or more central processing units (CPUs) and one or more memory subsystems. Computer systems also typically include peripheral devices for inputting and outputting data. Some common peripheral devices include, for example, monitors, keyboards, printers, modems, hard disk drives, floppy disk drives, and network controllers. The various components of a computer system communicate and transfer data using various buses and other communication channels that interconnect the respective communicating components.

One of the important factors in the performance of a computer system is the speed at which the CPU operates. Generally, the faster the CPU operates, the faster the computer system can complete a designated task. One method of increasing the speed of a computer is using multiple CPUs, commonly known as multiprocessing. With multiple CPUs, tasks may be executed substantially in parallel as opposed to sequentially.

Some systems, for example, include multiple CPUs connected via a processor bus. To coordinate the exchange of information among the processors, a host controller or switch is generally provided. The host controller is further tasked with coordinating the exchange of information between the plurality of processors and the system memory. The host controller may be responsible not only for the exchange of information in the typical read-only memory (ROM) and the random access memory (RAM), but also the cache memory in high speed systems. Cache memory is a special high speed storage mechanism which may be provided as a reserved section of the main memory or as an independent high-speed storage device. Essentially, the cache memory is a portion of the RAM which is made of high speed static RAM (SRAM) rather than the slower and cheaper dynamic RAM (DRAM) which may be used for the remainder of the main memory. When a program needs to access new data, the operating system first checks to see if the data is stored in the cache before reading it from main memory. By storing frequently accessed data and instructions in the SRAM, the system can minimize its access to the slower DRAM and thereby increase the request processing speed in the system and improve overall system performance.

Each computer generally includes an operating system (O/S), such as DOS, OS/2, UNIX, Windows, etc., to run program applications and perform basic functions, such as recognizing input from the keyboard, sending output to the display screen, keeping track of files and directories stored in memory, and controlling peripheral devices such as disk drives and printers. Operating systems provide a software platform on top of which application programs can run. For large systems, the O/S may allow multiprocessing (running a program on more than one processor), multitasking (allowing more than one program to run concurrently), and multithreading (allowing different parts of a single program to run concurrently).

When a computer system is powered-up, the O/S generally loads into main memory. The O/S includes a kernal which is the central module in the operating system. The kernal is the first part of the O/S to load into the main memory, and it remains in main memory while the system is operational. Typically, the kernal, or “scheduler” as it is sometimes designated, is responsible for memory management, process and task management, and disk management. In most systems, the kernal schedules the execution of program segments, or “threads,” to carry out system functions and requests.

Regardless of whether the system is a single computer or a network of computers (wherein each individual computer represents a “node” in the system), multiprocessing design schemes are generally implemented. One widely used multiprocessor architecture scheme is “Symmetric Multiprocessing” (SMP). In SMP systems, each processor is given equal priority and the same access to the system's resources, including a shared memory. SMP systems use a single operating system which shares a common memory and common resources. Thus, each processor accesses the memory via the same shared bus. Memory symmetry means that each processor in the system has access to the same physical memory. Memory symmetry provides the ability for all processors to execute a single copy of the operating system (O/S) and allows any idle processor to be assigned any tasks. Existing system and application software will execute the same, regardless of the number of processors installed in a system. The O/S provides the mechanism for exploiting the resources available in the system. The O/S schedules the execution of code on the first available processor, rather than for execution on a pre-assigned specific processor. Thus, processors generally execute the same amount of code, hence the term “symmetric multiprocessing.” All work is generally run through a common funnel, and then distributed among the multiple processors in a symmetric fashion, on the basis of processor availability. Further, a system may be configured such that it may be partitioned into one or more smaller SMP partitions. The partitioning and management of nodes in an SMP system provides for a variety of design challenges. One of the problems associated with managing a partitionable system is providing a flexible addressing scheme such that the operating systems and port agents are able to seamlessly access system addresses.

The present invention addresses one or more of the problems set forth above.

### BRIEF DESCRIPTION OF THE DRAWINGS

The foregoing and other advantages of the invention will become apparent upon reading the following detailed description and upon reference to the drawings in which:

FIG. 1 is a block diagram illustrating an exemplary multi-processor based system;

FIG. 2 is a block diagram illustrating an exemplary partitionable system including a plurality of multi-processor based systems;

FIG. 3 is an alternate view of the system configuration illustrated in FIG. 2;

FIG. 4 is a graphic illustration of a GSA map corresponding to the exemplary embodiment illustrated in FIG. 3;

FIG. 5 illustrates an exemplary PSA map in accordance with the present techniques;

FIG. 6 illustrates a mapping of an exemplary two-port system implementing two operating systems in accordance with the present techniques; and

FIG. 7 illustrates a mapping of an exemplary two-port system implementing a single operating system in accordance with the present techniques.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

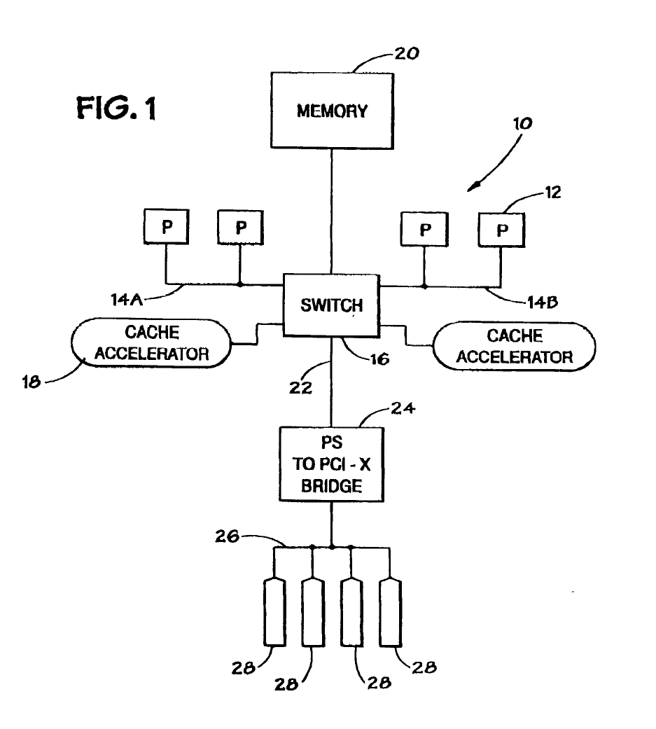

Turning now to the drawings, and referring initially to FIG. 1, a multiprocessor computer system is illustrated and designated by the reference numeral 10. The system 10 generally illustrates an exemplary SMP architecture. In this embodiment of the system 10, multiple processors 12 control many of the functions of the system 10. The processors 12 may be, for example, Pentium, Pentium Pro, Pentium II Xeon (Slot-2), Pentium III, or Pentium IV processors available from Intel Corporation. However, it should be understood that the number and type of processors are not critical to the technique described herein and are merely being provided by way of example.

Typically, the processors 12 are coupled to one or more processor buses. In this embodiment, half of the processors 12 are coupled to a processor bus 14A, and the other half of the processors 12 are coupled to a processor bus 14B. The processor buses 14A and 14B transmit the transactions between the individual processors 12 and a switch 16. The switch 16 directs signals between the processor buses 14A and 14B, cache accelerator 18, and memory 20. A crossbar switch is shown in this embodiment, however, it should be noted that any suitable type of switch or connection may be used in the operation of the system 10.

The switch 16 generally includes one or more application specific integrated circuit (ASIC) chips. The switch 16 may include address and data buffers, as well as arbitration logic and bus master control logic. The switch 16 may also include miscellaneous logic, such as error detection and correction logic. Furthermore, the ASIC chips in the switch may also include logic specifying ordering rules, buffer allocation, transaction type, and logic for receiving and delivering data.

The memory 20 may include a memory controller (not shown) to coordinate the exchange of information to and from the memory 20. The memory controller may be of any type suitable for such a system, such as, a Profusion memory controller. It should be understood that the number and type of memory, switches, memory controllers, and cache accelerators are not believed to be critical to the technique described herein and are merely being provided by way of example.

The switch 16 is also coupled to an input/output (I/O) bus 22. As mentioned above, the switch 16 directs data to and from the processors 12 through the processor buses 14A and 14B, as well as the cache accelerator 18 and the memory 20. In addition, data may be transmitted through the I/O bus 22 to one or more bridges such as the PCI-X bridge 24. The PCI-X bridge 24 is coupled to a PCI-X bus 26. Further, the PCI-X bus 26 terminates at a series of slots or I/O interfaces 28 to which peripheral devices may be attached. It should be understood that the type and number of bridges, I/O interfaces, and peripheral devices (not shown) are not believed to be critical to the technique described herein and are merely provided by way of example.

Generally, the PCI-X bridge 24 is an application specific integrated circuit (ASIC) comprising logic devices that process input/output transactions. Particularly, the ASIC chip may contain logic devices specifying ordering rules, buffer allocation, and transaction type. Further, logic devices for receiving and delivering data and for arbitrating access to each of the buses 26 may also be implemented within the bridge 24. Additionally, the logic devices may include address and data buffers, as well as arbitration and bus master control logic for the PCI-X bus 26. The PCI-X bridge 24 may also include miscellaneous logic devices, such as counters and timers as conventionally present in personal computer systems, as well as an interrupt controller for both the PCI and I/O buses and power management logic.

Typically, a transaction is initiated by a requestor, e.g., a peripheral device (not shown), coupled to one of the I/O interfaces 28. The transaction is then transmitted to the PCI-X bus 26 from one of the peripheral devices coupled to the I/O interface 28. The transaction is then directed towards the PCI-X bridge 24. Logic devices within the bridge 24 allocate a buffer where data may be stored. The transaction is directed towards either the processors 12 or to the memory 20 via the I/O bus 22. If data is requested from the memory 20, then the requested data is retrieved and transmitted to the bridge 24. The retrieved data is typically stored within the allocated buffer of the bridge 24. The data remains stored within the buffer until access to the PCI-X bus 26 is granted. The data is then delivered to the requesting device.

In the present embodiment, the bus 26 is potentially coupled to up to four peripheral devices. It should be noted that only one device may use the bus 26 to transmit data during any one clock cycle. Thus, when a transaction is requested, the device may have to wait until the bus 26 is available for access. It should be further noted that the buses 26 may be coupled to additional peripheral devices.

Systems such as the system 10, illustrated in FIG. 1, may be networked together via some type of interconnect. The interconnect provides a mechanism whereby smaller systems can be joined together to form nodes in a larger system. In an SMP system incorporating a number of smaller systems or nodes, the system may be configured such that it may be partitionable to provide any of a number of desired system configurations or architectures. In a multi-node SMP architecture, system resource management becomes more complex. Providing a system with the ability to share resources in a shared memory SMP manner is often desirable.

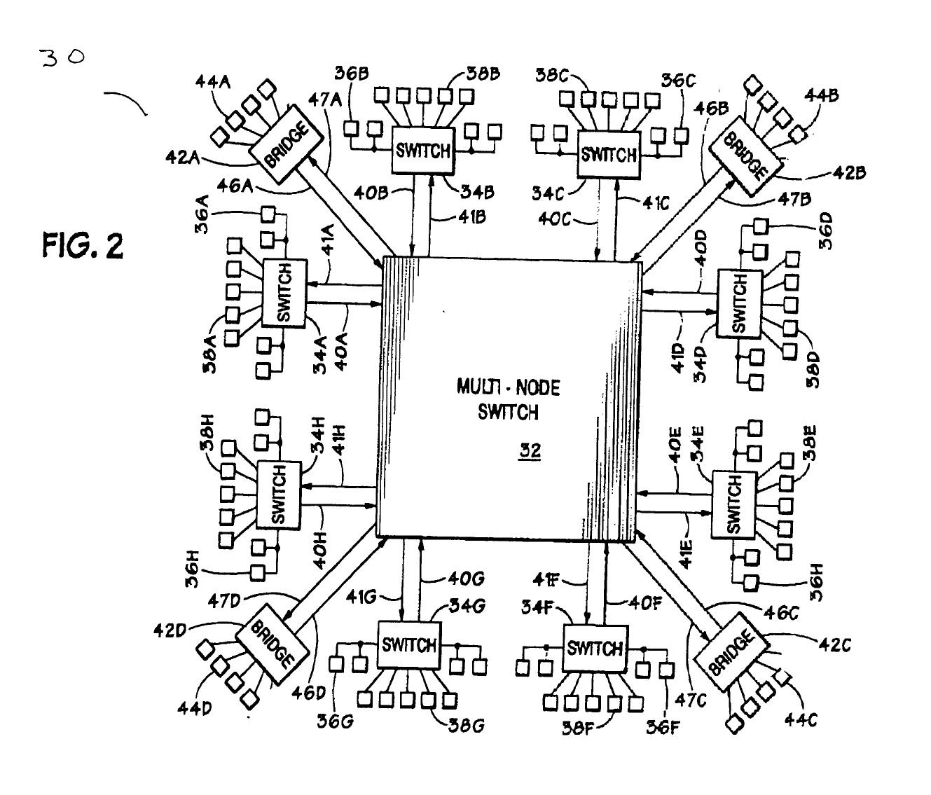

FIG. 2 is a block diagram illustrating an exemplary multi-node partitionable system, generally designated by reference numeral 30. The system 30 generally incorporates a number of smaller systems, such as the system 10 illustrated in FIG. 1, by connecting multiple CPU and I/O nodes through a switch architecture. The multi-node interconnect is a high-speed, high bandwidth system of buses connecting up to twelve individual nodes together through a multi-node switch 32 forming a large monolithic Cache Coherent architecture or several soft partitioned smaller systems, each running an individual operating system or a combination. The multi-node interconnect will be discussed further below. The multi-node interconnect may also work without the multi-node switch 32 to connect a single CPU node to an I/O node. Further, while the embodiment illustrated in FIG. 2 shows a computer architecture comprising up to twelve individual nodes, it should be evident that the number of nodes incorporated into the system 30 may vary from system to system.

The system 30 includes eight host controllers or switches 34A-34H which direct signals among corresponding processors 36A-36H. Nodes comprising the switches 34A-34H may be referred to as “CPU nodes” or “CPU ports.” As with the system 10, illustrated in FIG. 1, each switch 34A-34H may include address and data buffers, as well as arbitration logic and bus master control logic. Further, each switch 34A-34H may include logic specifying ordering rules, buffer allocation, transaction type, logic for receiving and delivering data, and miscellaneous logic, such as error detection and correction logic. In the present embodiment, each switch 34A-34H is coupled to four corresponding CPUs 36A-36H as well as five memory segments 38A-38H. Each of the five memory segments, such as those illustrated as memory segments 38A, may comprise a removable memory cartridge to facilitate hot-plug and segment replacement capabilities. Each of the five memory segments 38A-38H connected to the switches 34A-34H may include an independent memory controller to control the corresponding segment of the memory and to further facilitate hot-plug capabilities as well as memory striping and redundancy for fault tolerance, as can be appreciated by those skilled in the art. Exemplary systems describing hotplug capabilities, memory striping and redundancy can be found at U.S. patent application Ser. Nos. 09/770,759 and 09/769,957, each filed on Jan. 25, 2001, and each of which is incorporated by reference herein. Each of the switches 34A-34H may be connected to the multinode switch 32 by one or more unidirectional buses 40A-40H and 41A-41H. While the exemplary embodiment illustrated in FIG. 2 illustrates a single unidirectional bus going from each switch 34A-34H to the multi-node switch 32 and a single unidirectional bus going from the multi-node switch 32 to each switch 34A-34H, multiple unidirectional, bidirectional, or omnidirectional buses may also be implemented.

The system 30 also includes four VO nodes or ports. Each I/O port includes a bridge 42A-42D, such as a PCI-X bridge. As discussed with reference to the bridge 24 illustrated in FIG. 1, each bridge 42A-42D may include one or more ASIC chips which include logic devices specifying ordering rules, buffer allocation, and transaction type. Further, the logic devices in each bridge 42A-42D may include address and data buffers, arbitration control logic, logic devices for receiving and delivering data, interrupt controllers, and miscellaneous logic such as counters and timers, for example. Each bridge 42A-42D terminates at a series of I/O interfaces 44A-44D to which peripheral devices may be attached. As described with reference to the bridge 24 and I/O interfaces 28 in FIG. 1, the number of bridges, I/O interfaces, and peripheral devices may vary depending on particular system requirements. Each bridge 42A-42D is connected to the multi-node switch 32 via one or more buses. In the present embodiment, each bridge 42A-42D is connected to the multi-node switch 32 via a unidirectional bus 46A-46D which carries signals from a respective bridge 42A-42D to the multi-node switch 32, and a unidirectional bus 47A-47D which carries signals from the multi-node switch 32 to a corresponding I/O bridge 42A-42D.

For simplicity, the buses 40A-40H, 41A-41H, 46A-46D, and 47A-47D may be referred to collectively as the multi-node interconnect or multi-node bus. In this embodiment, the multi-node bus is a source synchronous unidirectional set of buses to/from the CPU and I/O nodes to/from the multi-node switch 32. Each set of buses may for example comprise one address bus OUT, one address bus IN, one data bus OUT, and one data bus IN. The terms “IN” and “OUT” for the address and data buses are referenced to the CPU/IO node or the multi-node switch 32. The multi-node bus connects the outputs of a node to the inputs of the multi-node switch 32. Conversely, the outputs of the multi-node switch 32 are connected to the inputs of the node. In the case of a stand alone system without a multi-node switch 32, the outputs of the CPU/IO node are connected to the inputs of another CPU/IO node. While the present embodiment of the multi-node bus indicates independent unidirectional IN/OUT source synchronous ports between the nodes and the multi-node switch 32, bi-directional buses may also be used.

Within each CPU node (as defined by the presence of the switches 34A-34H and associated CPUs 36A-36H) is a memory subsystem (here memory segments 38A-38H) and a memory subsystem directory. The directory handles all traffic associated with its corresponding memory. A local request is considered to be a request starting on one node and accessing the memory and directory on that node. A remote request is considered to be a request starting at one node and going through the multi-node switch 32 to another node's memory and directory. A remote request references the remote node's directory. The directory or memory controller keeps track of the owner of the cache lines for its corresponding memory. The owner of the cache lines may be the local node's memory, a local node's processor bus or buses, or a remote node's processor bus or buses. For the case of shared memory, multiple owners can exist locally or remotely.

The presently described multi-node switch 32 includes up to four data chips and one address chip, for example. Each of the chips within the multi-node switch 32 are synchronously tied together, and the four data chips work in unison receiving and delivering data from one node to another. The address chip controls the flow of data into and out of the data chips through synchronous operation from the address chip to the data chips. Additionally, when a control packet with data is sent from one node to another, a fixed time delay may exist between the delivering of the control packet and the delivery of the corresponding data to insure that proper timing requirements are met. The address chip in this embodiment handles twelve identical interfaces to the CPU and I/O nodes. The address chip passes control packets from one node to another. The control packet is received by the address chip and is routed to the destination CPU/IO node. This exemplary embodiment of the multi-node switch 32 is simply provided for purposes of illustration and is not critical to the present techniques.

It is often desirable to partition a large SMP system, such as the system 30, into smaller SMP partitions. A partition includes one or more groupings of ports that can share resources in a shared memory SMP manner, as further described below. The partitions are established through the use of a management processor that maps a physical address into a plurality of virtual addresses. Generally speaking, “virtual memory” is an alternate set of memory addresses to that of physical memory addresses. Programs often use virtual addresses rather than physical addresses to store instructions and data. When the program is actually executed, the virtual addresses may be converted into physical addresses. The purpose of virtual memory is to enlarge the address space (i.e., the set of addresses a program can utilize). For example, virtual memory might contain twice as many addresses as physical memory. Thus, a program using all of the available virtual memory would not actually fit in the physical memory. Nevertheless, the system may execute such a program by copying into physical memory the portions of the program needed at any given point during execution. To facilitate the copying of virtual memory into physical or real memory, an operating system divides virtual memory into pages, each of which contains a fixed number of addresses. Each page is stored on a disk until it is needed. When the page is needed, the operating system copies it from disk to the physical memory, translating the virtual addresses into real addresses in the process. This process of translating virtual addresses into real or physical addresses is called “mapping.” The copying of virtual pages from disk to memory is known as “paging” or “swapping.”

These general concepts may be applied to the present system to facilitate the partitioning of various nodes. When various nodes are partitioned, the operating system generally needs to know which physical memory addresses it is accessing. By adding an additional abstraction layer to the system hardware which abstracts the operating system through a virtual addressing scheme, the physical address assignments do not need to be understood by the operating system. Thus, the present system incorporates two distinct address views: Global System Address (GSA) and Port System Address (PSA). The GSA can be described as a fixed address range for each physical port and associated resources. The GSA represents the physical memory and is not directly accessible by port agents such as CPUs and I/O devices. The PSA is a zero-based address range of the system as viewed by a particular port agent. The PSA addresses are accessible by the operating systems and I/O masters. PSA represents a virtual view of a set of accessible GSA resources mapped to a particular partition.

In typical partitionable systems, a CPU node or an I/O node has direct access to the physical memory addresses. Conversely, programs being executed on the CPUs view a virtual address rather than the physical address. The virtual addresses provide an abstraction layer to be utilized by a program. In the presently described embodiment, the program still views a set of virtual addresses rather than the physical addresses. However, the CPU nodes (and associated memory) and the I/O nodes include an abstraction layer and are therefore shielded from accessing the physical addresses. Here, the PSA provides a layer of hardware abstraction in much the same way that typical virtual memory is provided to shield a program from directly accessing the physical memory spaces.

The present system 30 includes 8 CPU/memory ports (1-8) and four I/O ports (9-12). A “node” plugs into a port. PORTs 1-8 can function as a host node since each of the nodes include one or more CPUs (here four) and a range of physical memory to store an operating system. When a system, such as the system 30, is partitioned, a set of host nodes (1-8) and possibly one or more I/O nodes (9-12) are grouped to form a computer.

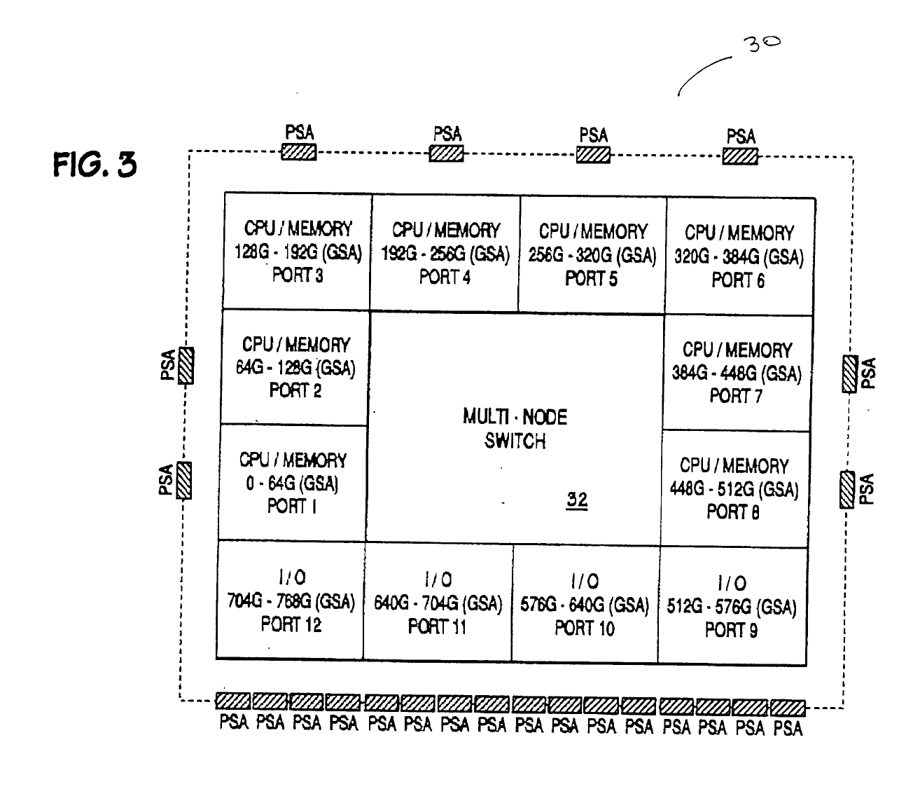

FIG. 3 illustrates an alternate view of the system discussed with reference to FIG. 2 wherein each port is illustrated along with one or more corresponding PSAs. Each port indicates a cluster of components. For example, PORT 1 (illustrated in FIG. 3) represents a cluster such as the switch 34A, the CPUs 36A and the memory segments 38A, as indicated in FIG. 2. As with the illustration in FIG. 2, the present system 30 includes eight CPU/memory ports comprising the corresponding switches 34A-34H, CPUs 36A-36H, and memory segments 38A-38H. Similarly, the four I/O ports, shown as PORTs 9-12 in FIG. 3, each include a corresponding bridge 44A-44D (FIG. 2) and I/O ports 44A-44D.

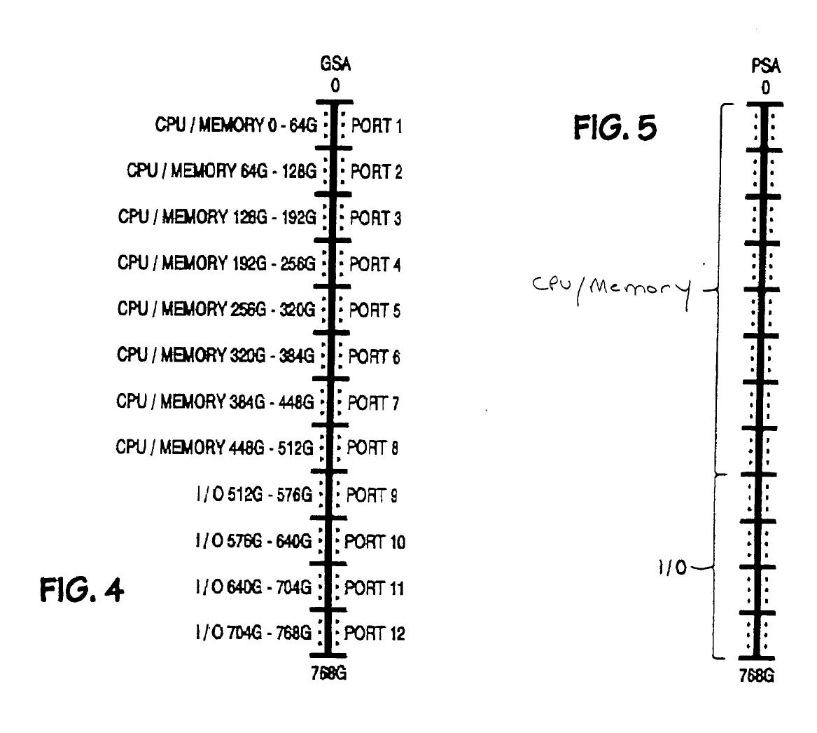

An exemplary system, such as the system 30, may include up to 768G of physical memory space. Thus, in the physical memory, each port is assigned a 64G GSA footprint. PORTs 1-8, corresponding to CPU/memory ports, occupy 0-512G GSAs. PORT 1, for example, occupies 0-64G GSA. PORT 2 occupies 64-128G GSA, and so forth. The I/O ports occupy 512-768G GSAs. Thus, for example, I/O PORT 9 occupies 512-576G GSA as indicated in FIG. 3, and so forth. The GSA map for each port is only accessible by the management processors and software and is not directly accessible by the port agents such as the CPUs and I/O devices. Each of the CPU/memory PORTs 1-8 include a layer of PSAs to be viewed by the port agents. In the present system, each of the I/O PORTs 9-12 includes up to four PSAs, one for each of the I/O ports 28, illustrated in FIG. 1. The GSA and PSA maps are discussed further below with reference to FIGS. 4-7.

FIG. 4 is a graphic illustration of the GSA map corresponding to the exemplary embodiment illustrated with reference to FIG. 3. As previously indicated, the present system includes twelve ports occupying a total of 768G. Each port has a 64G GSA address range which can be divided into four 16G pages through the PSA view. As with the total addressability of each GSA, the page address range may vary from system to system. As previously described with reference to FIG. 3, PORTs 1-8 are CPU/memory ports occupying 0-512G GSAs. PORTs 9-12 are I/O ports occupying 512-768G GSAs.

To provide a system, such that the partitioning of the system is flexible (e.g., PORTs 1-4 may form a partition and PORTs 6, 7, and 9 may form a partition and PORT 8 may form a partition, for example) the operating system running on each of the partitions cannot be assigned a fixed memory range to allow for variability in partitioning. Most operating systems are zero-based. That is to say that the operating system assumes that the accessible address range corresponding to the O/S begins with zero. Since the system is flexible and may be configured to form a number of partitions wherein one or more ports are grouped together, the operating system cannot be mapped to a single address configuration. To allow the system to implement commercially available operating systems and provide a flexible, partitionable system, the entire GSA space is mapped into every PSA view to provide the O/S with an abstraction to the fixed address range.

FIG. 5 illustrates a PSA map. As previously described, the PSA is a logical or virtual representation of the GSA, which has the same (or greater) addressability as the GSA and provides a virtual abstraction layer between the port (CPU/memory or I/O). Each PSA view is fully addressable to at least 768G. As illustrated in FIG. 3, there is one PSA view per CPU/memory port and four PSA views per I/O port. Alternate embodiments of the present system may include variations in the number of PSAs implemented. As with the GSA map, each PSA view is divided into four 16G pages.

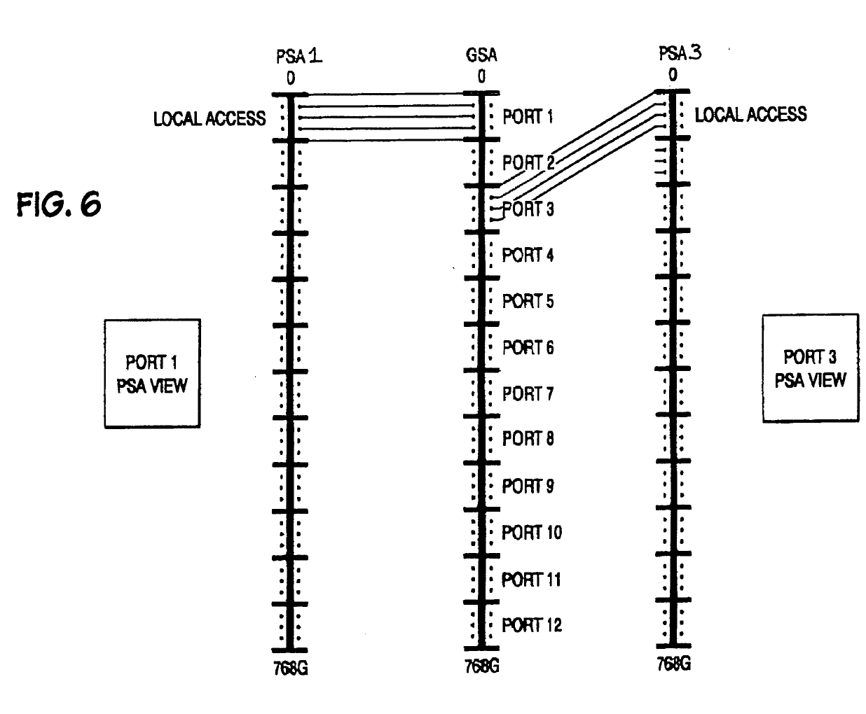

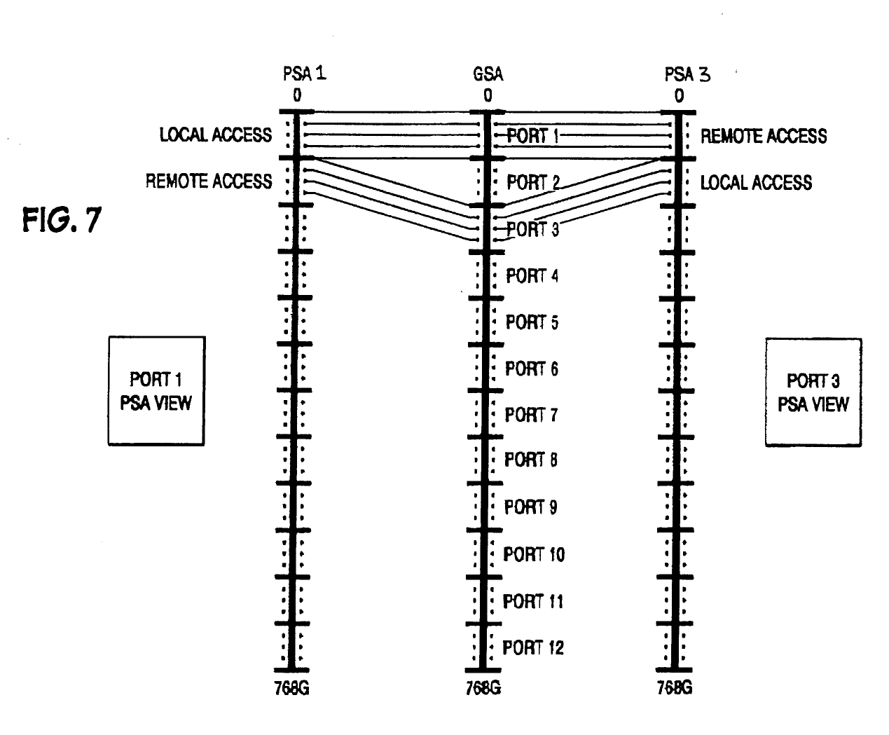

To illustrate the implementation of the port abstraction layer (i.e., the PSA) an exemplary system comprising two partitions is illustrated with reference FIGS. 6 and 7. In particular, FIG. 6 illustrates a two port partition implementing PORT 1 and PORT 3. Each port implements a respective O/S. Each port views the GSA through the mapping provided by a respective PSA. Thus, PORTs 1 and 3 are blind to the configuration of the GSA. If PORT 1 wants to access its own memory, it must be mapped such that the virtual PSA 1 address maps to its corresponding memory (i.e., 0-64G in the GSA). Likewise, PORT 3 also views 0-64G on its respective PSA 3. However, 0-64G on PSA 3 is mapped to GSA addresses 128-192G. Thus, the operating system loaded on PORT 1 and the operating system loaded on PORT 3 access different portions of the physical memory, but both operating systems see a zero-based address through their corresponding PSA.

FIG. 7 illustrates a single partition wherein PORTS 1 and 3 run a single operating system. That is to say that the same operating system runs on both nodes. Both the PSA associated with PORT 1 and the PSA associated with PORT 3 must be mapped to the same GSA. In the example illustrated, each PSA accesses 0-128G of address space. Each PSA address space (here 0-128G) must be mapped to the GSA in the same way. Here, the operating system simply sees 0-128G but the mapping to the GSA (invisible to the O/S) maps each port to the appropriate GSA. If PORT 1 accesses memory corresponding to 0-64G, it will be a local access since 0-64G on PSA 1 maps to 0-64G GSA from PORT 1. However, if PORT 3 accesses the memory in 0-64G GSA, the access is remote with respect to PORT 3 since that address space is assigned to PORT 1 in the GSA. Similarly, if PORT 3 accesses 64-128G on PSA 3, it is a local access mapped to 128-192G GSA. In order for PORT 1 to access the same physical address space (i.e., 128-192G GSA) the PSA corresponding to PORT 1 (i.e., PSA 1) accesses the address space remotely and views the same physical GSA addresses as 64-128G PSA 1.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system comprising:
a system switch configured to direct an exchange of information in the system;
a plurality of ports each configured to couple one or more port agents to the system switch;
a plurality of global system addresses comprising a single fixed range of physical addresses for the system, wherein the global system addresses are not directly accessible by the port agents; and
a plurality of port address ranges, each of the port address ranges corresponding to one of the plurality of ports and comprising a plurality of virtual memory addresses directly accessible by the corresponding port agents and mapped to the plurality of global system addresses to provide indirect access from the port agents to the global system addresses.

2. The system, as set forth in claim 1, comprising one or more port agents coupled to each of the plurality of ports.

3. The system, as set forth in claim 2, wherein a first plurality of the one or more port agents each comprises each of one or more processors and one or more memory devices.

4. The system, as set forth in claim 3, wherein each of the first plurality of port agents comprises a corresponding port address range accessible to its respective port agent.

5. The system, as set forth in claim 2, wherein a second plurality of the one or more port agents each comprises one or more input/output devices.

6. The system, as set forth in claim 5, wherein each of the second plurality of port agents comprises a corresponding port address range for each of the input/output devices.

7. The system, as set forth in claim 1, comprising an interconnect coupled between the system switch and each of the plurality of ports.

8. The system, as set forth in claim 7, wherein the interconnect comprises a plurality of source synchronous unidirectional buses.

9. The system, as set forth in claim 1, wherein each of the plurality of port address ranges comprises the same size as the single fixed range of physical addresses.

10. The system, as set forth in claim 1, wherein each of the plurality of port address ranges is zero-based.

11. A symmetric multiprocessing system comprising:
a finite range of system addresses; and
a plurality of partitionable nodes, wherein each of the partitionable nodes comprises:
at least one of a processor and an input/output device; and
a range of virtual port addresses corresponding to a respective node and mapped to unique addresses in the finite range of system addresses.

12. The symmetric multiprocessing system, as set forth in claim 11, wherein the finite range of system addresses comprises 0-768G.

13. The symmetric multiprocessing system, as set forth in claim 12, wherein each range of virtual port addresses corresponding to each respective node comprises 0-768G.

14. The symmetric multiprocessing system, as set forth in claim 11, wherein the system comprises eight processor nodes each comprising at least one processor coupled to at least one memory device, and wherein the system comprises four input/output nodes each comprising at least one input/output device.

15. The symmetric multiprocessing system, as set forth in claim 11, comprising:
a control mechanism configured to control the multiprocessing system; and
an interconnection mechanism configured to couple each of the plurality of nodes to the control mechanism.

16. A method of accessing a fixed address segment in a multi-node system comprising the acts of:
accessing a first range of addresses from a device on a first node, wherein the first range of addresses is directly accessible by devices on the first node only, and wherein the first range of addresses comprises a virtual range of addresses;
checking a control device in the multi-node system to determine a mapping of the first range of addresses to a second range of addresses, wherein the second range of addresses comprises a fixed address segment; and
accessing the second range of addresses from the device on the first node through the first range of addresses.

17. The method, as set forth in claim 16, comprising the act of implementing a single operating system.

18. The method, as set forth in claim 16, comprising the acts of:
implementing two or more operating systems; and
accessing a third range of addresses from a second device on a second node, wherein the third range of addresses is directly accessible by devices on the second node only, and wherein the third range of addresses comprises a virtual range of addresses.

19. The method, as set forth in claim 18, comprising the act of accessing the second range of addresses from the second device on the second node through the third range of addresses.

20. The method, as set forth in claim 19, wherein the act of accessing the second range of addresses from the second device on the second node comprises the act of remotely accessing the second range of addresses.
